(19) United States
(12) Patent Application Publication
(10) Pub. No.: US 2026/0105567 A1
(43) Pub. Date: Apr. 16, 2026

(54) UPSCALING AND RESTORATION OF GENERATED IMAGES

(71) Applicant: Samsung Electronics Co., Ltd., Suwon-si (KR)

(72) Inventors: Hong-Hoe Kim, Aliso Viejo, CA (US); Yingnan Zhu, Irvine, CA (US)

(21) Appl. No.: 18/955,458

(22) Filed: Nov. 21, 2024

Related U.S. Application Data
(60) Provisional application No. 63/706,570, filed on Oct. 11, 2024.

(51) Int. Cl. G06T 3/4046; G06F 18/241; G06T 3/4053; G06T 5/60; G06T 5/80; G06T 7/11; G06T 11/00

(52) U.S. Cl. CPC G06T 3/4046; G06F 18/241; G06T 3/4053; G06T 5/60; G06T 5/80; G06T 7/11; G06T 11/00; G06T 2207/20084; G06T 2207/30168

(57) ABSTRACT

A method includes obtaining, using at least one processing device of an electronic device, an image created by a generative artificial intelligence (AI) model. The method also includes identifying, using the at least one processing device, at least one distortion in the image. The method further includes performing, using the at least one processing device, restoration on the at least one identified distortion in the image based on a restoration model to generate a restored image. The method also includes upscaling, using the at least one processing device, the restored image based on a generative adversarial network (GAN)-based upscale model to generate an upscaled image. In addition, the method includes outputting, using the at least one processing device, the upscaled image.

### CROSS-REFERENCE TO RELATED APPLICATION AND PRIORITY CLAIM

This application claims priority under 35 U.S.C. § 119(e) to U.S. Provisional Patent Application No. 63/706,570 filed on Oct. 11, 2024, which is hereby incorporated by reference in its entirety.

### TECHNICAL FIELD

This disclosure relates generally to image processing. More specifically, this disclosure relates to upscaling and restoration of generated images.

### BACKGROUND

With the growing interest in generative artificial intelligence (AI), use of generative AI models to create images for display to users on high-resolution devices is being contemplated. However, using the output from a generative AI model can have two significant problems. First, the output size is often small (such as full high definition or “FHD”), a common issue because generative AI models can typically generate only small-sized images due to computational costs. When the generated images are displayed on higher-definition displays (such as 4K), the image quality is low. Second, the generated images often have distortion problems, such as distorted faces or hands.

### SUMMARY

This disclosure relates to upscaling and restoration of generated images.

In a first embodiment, a method includes obtaining, using at least one processing device of an electronic device, an image created by a generative artificial intelligence (AI) model. The method also includes identifying, using the at least one processing device, at least one distortion in the image. The method further includes performing, using the at least one processing device, restoration on the at least one identified distortion in the image based on a restoration model to generate a restored image. The method also includes upscaling, using the at least one processing device, the restored image based on a generative adversarial network (GAN)-based upscale model to generate an upscaled image. In addition, the method includes outputting, using the at least one processing device, the upscaled image.

In a second embodiment, an electronic device includes at least one processing device configured to obtain an image created by a generative AI model. The at least one processing device is also configured to identify at least one distortion in the image. The at least one processing device is further configured to perform restoration on the at least one identified distortion in the image based on a restoration model to generate a restored image. The at least one processing device is also configured to upscale the restored image based on a GAN-based upscale model to generate an upscaled image. In addition, the at least one processing device is configured to output the upscaled image.

In a third embodiment, a non-transitory machine-readable medium contains instructions that when executed cause at least one processor to obtain an image created by a generative AI model. The non-transitory machine-readable medium also contains instructions that when executed cause the at least one processor to identify at least one distortion in the image. The non-transitory machine-readable medium further contains instructions that when executed cause the at least one processor to perform restoration on the at least one identified distortion in the image based on a restoration model to generate a restored image. The non-transitory machine-readable medium also contains instructions that when executed cause the at least one processor to upscale the restored image based on a GAN-based upscale model to generate an upscaled image. In addition, the non-transitory machine-readable medium contains instructions that when executed cause the at least one processor to output the upscaled image.

Any one or any combination of the following features may be used with the first, second, or third embodiment. The at least one distortion in the image may be identified by segmenting the image into different regions, identifying a classification for one of the regions, determining a confidence associated with the region based on the classification, and identifying the at least one distortion based on the confidence not exceeding a confidence threshold. A text prompt used by the generative AI model to generate the image may be obtained, and the classification associated with the region may be determined based on the text prompt. The at least one distortion in the image may be identified by obtaining a text prompt used by the generative AI model to generate the image, generating a negative prompt based on the text prompt, obtaining a negative image created by the generative AI model based on the negative prompt, and identifying that the image needs an additional restoration based on a distance between the negative image from the image not exceeding a distance threshold. The at least one distortion in the image may be identified by segmenting the image into different regions, smoothing one of the regions using a super resolution (SR) model, performing a region of interest (ROI) distance check between the region and the smoothed region, and identifying the at least one distortion based on a distance from the ROI distance check not exceeding a distance threshold. The restored image may be upscaled by performing an average pooling operation on the restored image, performing a first convolution operation on a result of the average pooling operation, performing a first rectified linear unit (ReLU) activation operation on a result of the first convolution operation, performing a second convolution operation on a result of the first ReLU activation operation, performing a sigmoid operation on a result of the second convolution operation, and generating an output model by multiplying a result of the sigmoid operation by features of the restored image. The restored image may also be upscaled by combining the output model with the restored image to generate a combined model, performing a second average pooling operation on the combined model, performing a third convolution operation on a result of the second average pooling operation, performing a second RcLU activation operation on a result of the third convolution operation, performing a fourth convolution operation on a result of the second ReLu activation operation, performing a second sigmoid operation on a result of the fourth convolution operation, and generating a second output model by multiplying a result of the second sigmoid operation by features of the combined model.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration that may be employed in conjunction with upscaling and restoration of generated images in accordance with this disclosure;

FIG. 2 illustrates an example process for upscaling and restoration of generated images in accordance with this disclosure;

FIG. 3 illustrates an example processing flow for upscaling and restoration of generated images in accordance with this disclosure;

FIGS. 4, 4A, and 4B illustrate an example of a generated image requiring restoration and enlarged views thereof in accordance with this disclosure;

FIG. 5 illustrates an example portion of the processing flow of FIG. 3 according to some embodiments of this disclosure;

FIG. 6 illustrates an example portion of the processing flow of FIG. 3 according to other embodiments of this disclosure;

FIG. 7 illustrates an example portion of the processing flow of FIG. 3 according to still other embodiments of this disclosure;

FIG. 8 illustrates an example of a restored image region corresponding to the region in FIG. 4A in accordance with this disclosure;

FIG. 9 illustrates an example portion of the processing flow of FIG. 3 according to one variant of this disclosure;

FIG. 10 illustrates an example portion of the processing flow of FIG. 3 according to another variant of this disclosure;

FIG. 11 illustrates an example upscaling portion of the processing flow of FIG. 3 in accordance with this disclosure;

FIG. 12 illustrates in greater detail an example deep feature extraction of FIG. 11 in accordance with this disclosure;

FIG. 13 illustrates in greater detail connections within the deep feature extraction of FIG. 11 in accordance with this disclosure;

FIG. 14 illustrates in greater detail an example structure of a basic block within the deep feature extraction of FIG. 11 in accordance with this disclosure; and

FIG. 15 illustrates another example upscaling portion of the processing flow of FIG. 3 in accordance with this disclosure.

### DETAILED DESCRIPTION

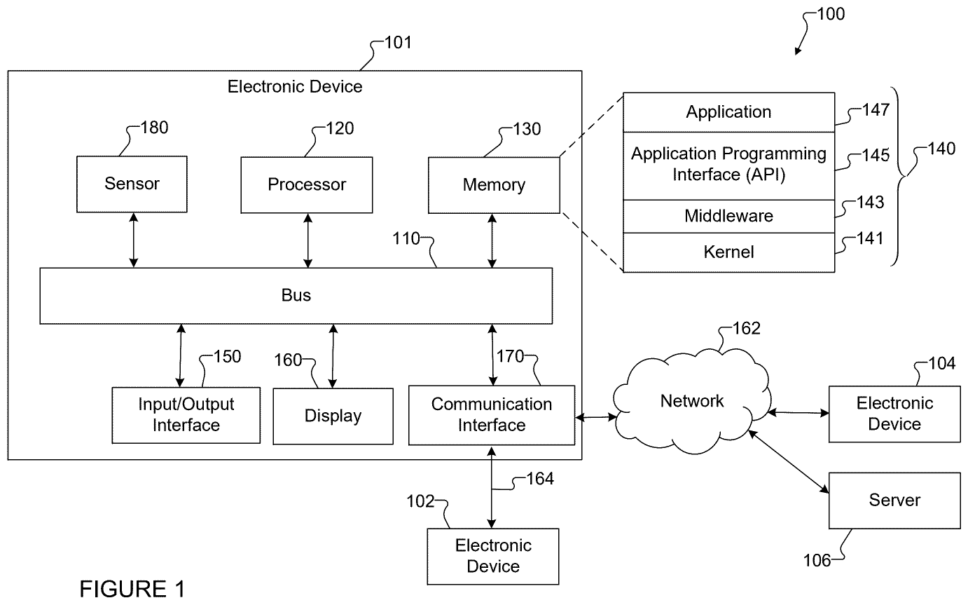

FIGS. 1 through 15, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, with the growing interest in generative artificial intelligence (AI), use of generative AI models to create images for display to users on high-resolution devices is being contemplated. However, using the output from a generative AI model can have two significant problems. First, the output size is often small (such as full high definition or “FHD”), a common issue because generative AI models can typically generate only small-sized images due to computational costs. When the generated images are displayed on higher-definition displays (such as 4K), the image quality is low. Second, the generated images often have distortion problems, such as distorted faces or hands.

To address small image sizes and distortion problems in generative AI-produced images, this disclosure provides various techniques for upscaling and restoration of generated images. Among other things, a quality check can be performed to determine if generated images have distorted areas. When the quality check finds problematic pixel areas, a restoration model can be used to improve the area(s) until the quality check passes. After that, the images can be input into a generative adversarial network (GAN)-based upscale model that upscales the (smaller) images into images with more pixels (such as 4K images) while keeping textures from the input images. Note that while this functionality is often described as being used in the context of images generated for presentation on televisions, this functionality may be used in any other suitable applications.

FIG. 1 illustrates an example network configuration that may be employed in conjunction with upscaling and restoration of generated images in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform various operations related to upscaling and restoration of generated images.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to upscaling and restoration of generated images. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as a head mounted display (or “HMD”)). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, which include one or more imaging sensors, or a VR or XR headset.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support the electronic device 101 by performing at least one of operations (or functions) implemented on the electronic device 101. For example, the server 106 can include a processing module or processor that may support the processor 120 implemented in the electronic device 101. As described in more detail below, the server 106 may perform various operations related to upscaling and restoration of generated images.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

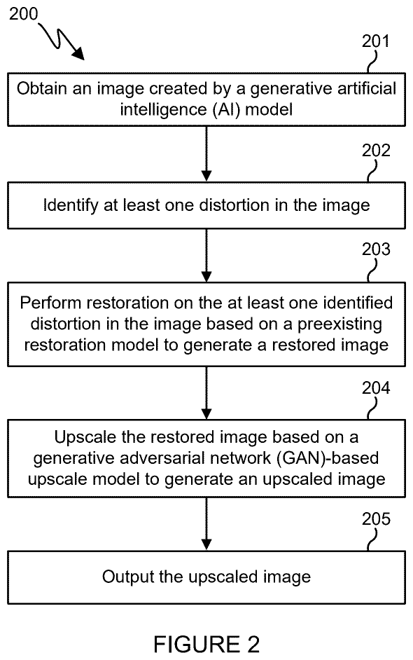

FIG. 2 illustrates an example process 200 for upscaling and restoration of generated images in accordance with this disclosure. For case of explanation, the process 200 of FIG. 2 is described as being performed using the electronic device 101 in the network configuration 100 of FIG. 1. However, the process 200 may be performed using any other suitable device(s) and in any other suitable system(s).

As shown in FIG. 2, the process 200 starts with obtaining an image created by a generative artificial intelligence (AI) model (step 201). The generated image may represent a relatively low resolution image requiring improvement for display on a high-resolution device. At least one distortion is identified in the image (step 202). Example distortions that could be identified may include distortions likely to draw the attention of a viewer, such as artifacts in human faces and human hands. Restoration is performed on the at least one identified distortion in the image based on a restoration model to generate a restored image (step 203). For example, face restoration and hand restoration may be performed on the generated image. The restored image is upscaled based on a generative adversarial network (GAN)-based upscale model to generate an upscaled image (step 204). In some cases, short skip connections and an average pooling operation may be employed in the GAN model to improve performance. The upscaled image is output (step 205). For example, the upscaled image may be displayed on a high-resolution device.

Although FIG. 2 illustrates one example of a process 200 for upscaling and restoration of generated images, various changes may be made to FIG. 2. For example, while shown as a series of steps, various steps in FIG. 2 could overlap, occur in parallel, occur in a different order, or occur any number of times (including zero times).

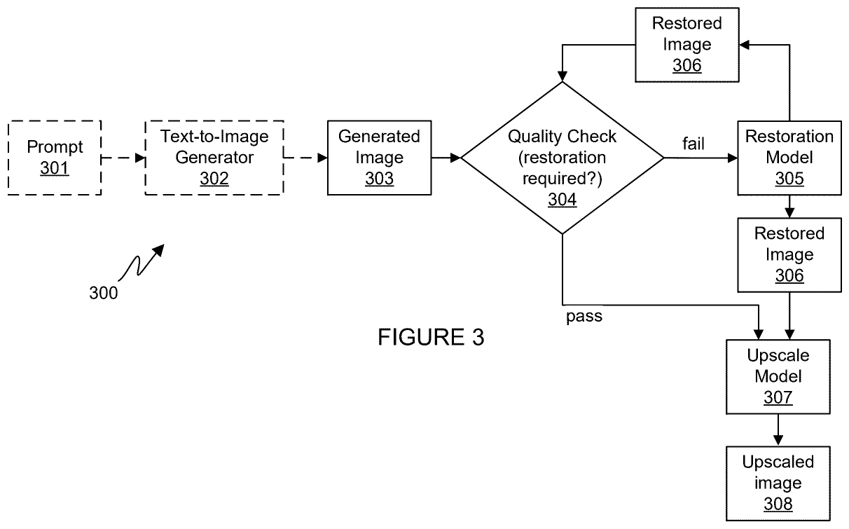

FIG. 3 illustrates an example processing flow 300 for upscaling and restoration of generated images in accordance with this disclosure. For ease of explanation, the processing flow 300 of FIG. 3 is described as being used by the electronic device 101 in the network configuration 100 of FIG. 1. However, the processing flow 300 may be used by any other suitable device(s) and in any other suitable system(s).

As shown in FIG. 3, the processing flow 300 begins with (optionally) receiving a prompt. For example, a user may enter the prompt “Draw a smiling woman with a hat enjoying the beach.” If received, the prompt can be passed to a text-to-image generator model 302, such as DALL-E, Gauss, Stable Diffusion, or the like. The output of the text-to-image generator model 302, or an input image received from an external source, represents a generated image 303. As can be seen here, the reception and processing of the prompt is optional since the generated image 303 may be obtained in other ways, such as from the external source.

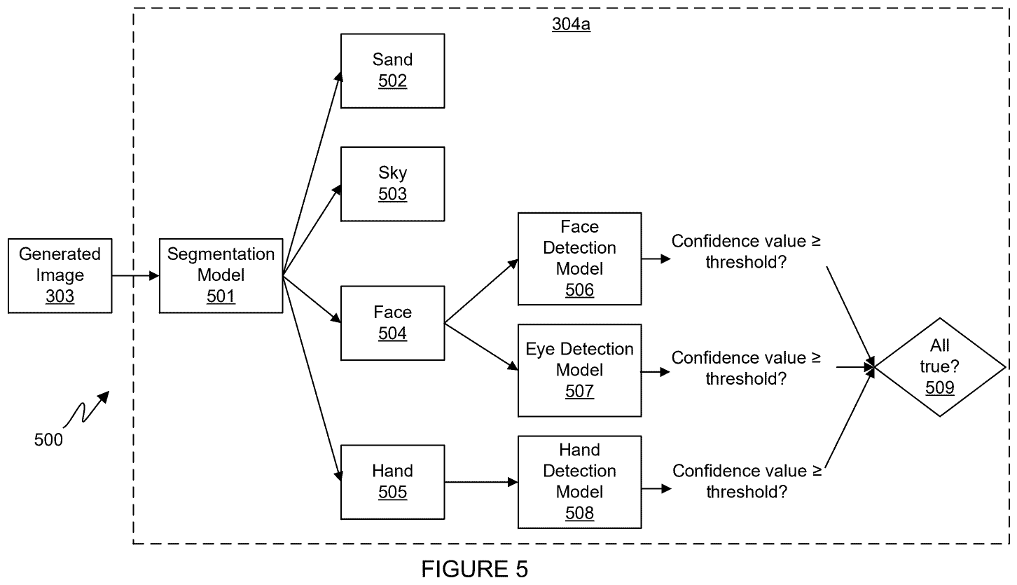

The generated image 303 may have a relatively small size or resolution (such as and FHD image). The generated image 303 is subjected to a quality check model 304, which determines whether the image needs restoration. For instance, if a hand in the image has the wrong number of fingers, the quality check model 304 can determine that the image needs restoration. Example embodiments of the quality check model 304 are described in further detail below in connection with FIGS. 5 through 7.

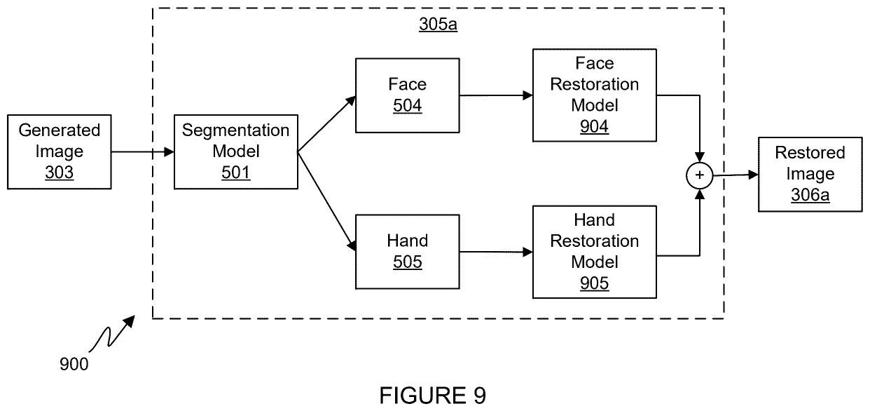

If the quality check model 304 determines that the generated image 303 needs restoration, the generated image 303 is passed to a restoration model 305. The restoration model 305 can process the generated image 303 in order to generate a restored image 306. The restoration model 305 may use any suitable techniques for restoring image details. One example of a restoration model 305 is described in further detail below in connection with FIG. 9.

The restored image 306 output by the restoration model 305 is again processed by the quality check model 304 to determine if further restoration is needed. The quality check model 304 can be iteratively applied to the output of the restoration model 305 until further restoration is no longer needed or desired. If the generated image 303 does not need restoration or if the output of the restoration model 305 does not need further restoration, the generated image 303 or the output of the restoration model 305 is passed to an upscaling model 307. The upscaling model 307 increases the resolution of the received image, such as by adding additional pixels to produce an upscaled image 308. The upscaling model 307 may use any suitable techniques to upscale images, such as by performing bilinear interpolation. The upscaled image 308 may be output, such as when the upscaled image 308 is displayed on the electronic device 101 (which in some cases might represent a television).

Although FIG. 3 illustrates one example of a processing flow 300 for upscaling and restoration of generated images, various changes may be made to FIG. 3. For example, other or additional enhancements may be made to a generated image. Examples of such enhancements could include filtering, contrast adjustment, and the like.

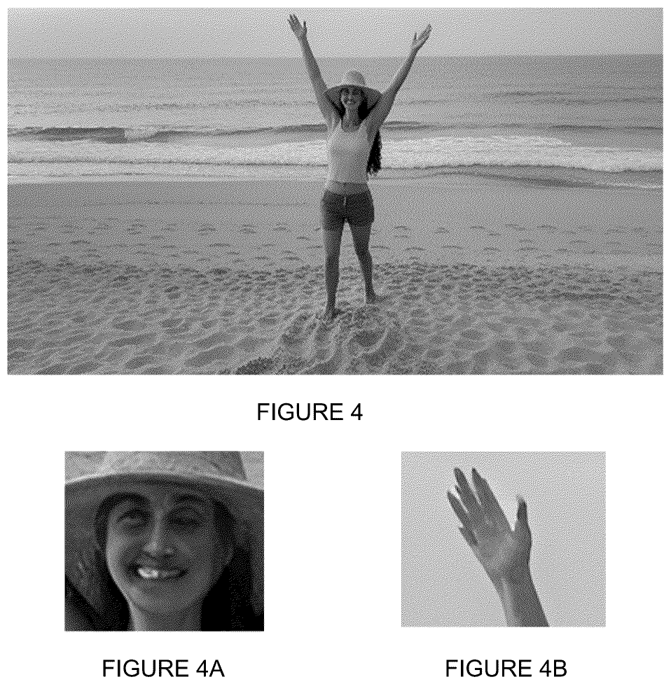

FIGS. 4, 4A, and 4B illustrate an example of a generated image requiring restoration and enlarged views thereof in accordance with this disclosure. As is apparent from FIG. 4A, one or both eyes and the teeth of the person in FIG. 4 may require restoration. As is apparent from FIG. 4B, the fingers of the person in FIG. 4 require restoration. An image restoration pipeline according to this disclosure can include the quality check model 304 and the restoration model 305. In some embodiments, the quality check model 304 may be configured to use a segmentation-based approach and/or a diffusion-based approach to detect that an image has a quality issue. Also, in some embodiments, the restoration model 305 may be configured to resolve the quality issue(s) of the image.

Although FIGS. 4, 4A, and 4B illustrate one example of a generated image requiring restoration and enlarged views thereof, various changes may be made to FIGS. 4, 4A, and 4B. For example, the types of image quality issues shown here are examples only, and restoration and upscaling may be needed to handle any other image quality issues.

FIG. 5 illustrates an example portion 500 of the processing flow 300 of FIG. 3 according to some embodiments of this disclosure. In the example shown, a quality check model 304a employs a segmentation-based approach in which a segmentation model 501 segments an image (such as the image of FIG. 4) into different regions. For example, for the image of FIG. 4, the generated image 303 may be segmented into region(s) of sand 502, region(s) of sky 503, regions of face(s) 504 (a single face for the image of FIG. 4 but potentially multiple faces for other images), and regions of hand(s) 505.

For the image of FIG. 4, because distorted pixels are (or may be) located in regions of face(s) 504 (including eye(s), such as the region of FIG. 4A) or regions of hand(s) 505 (the region of FIG. 4B), those regions may be input to corresponding detection models. For example, the regions of face(s) 504 may be input to a face detection model 506 and an eye detection model 507, while the regions of hand(s) 505 may be input to a hand detection model 508. In some cases, the face detection model 506, the eye detection model 507, and the hand detection model 508 can each output one or more bounding boxes and associated confidence values. If any of the confidence values are lower than one or more associated thresholds (determination 509), the quality check model 304a can determine that the generated image 303 needs further restoration. If all confidence values exceed the associated threshold(s), no further restoration may be needed.

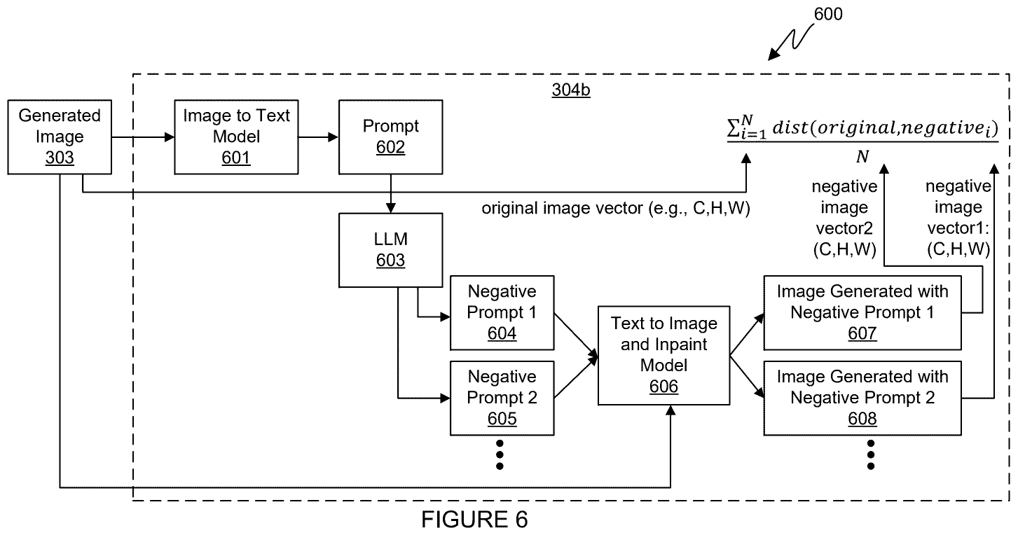

FIG. 6 illustrates an example portion 600 of the processing flow 300 of FIG. 3 according to other embodiments of this disclosure. In this example, a quality check model 304b employs an image-to-text model 601 to generate a prompt 602 for a text-to-image model. The prompt 602 can describe the generated image 303 (such as “a smiling woman wearing a hat” for the image of FIG. 4). The prompt 602 can be input to a large language model (LLM) 603 with image generation capabilities, along with directions to generate one or more negative prompts, such as negative prompt 1 604 and negative prompt 2 605. The negative prompts describe images that differ in some respect. For instance, for the image of FIG. 4, negative prompt 1 604 may be “a smiling cat wearing a hat,” and negative prompt 2 605 may be “a smiling man wearing a hat.”

The negative prompts are input into a text-to-image plus in-paint model 606, such as a Stable Diffusion model, to obtain one or more negative images 607-608. The one or more negative images 607-608 can be used to determine whether image restoration is needed, such as by determining whether a distance between the negative image(s) from the generated image does or does not exceed a distance threshold. In some embodiments, for example, the average distance between the image vector for the generated image 303 and the image vector(s) for the negative image(s) 607-608 may be determined as follows.

$${\sum }_{i = 1}^{N} dist ( original , {negative}_{i} ) ,$$

Here, N represents the number of negative images. When the computed distance is higher than a threshold, the quality check model 304b may determine that the generated image 303 is good enough. Otherwise, the quality check model 304b may determine that the generated image 303 needs further restoration.

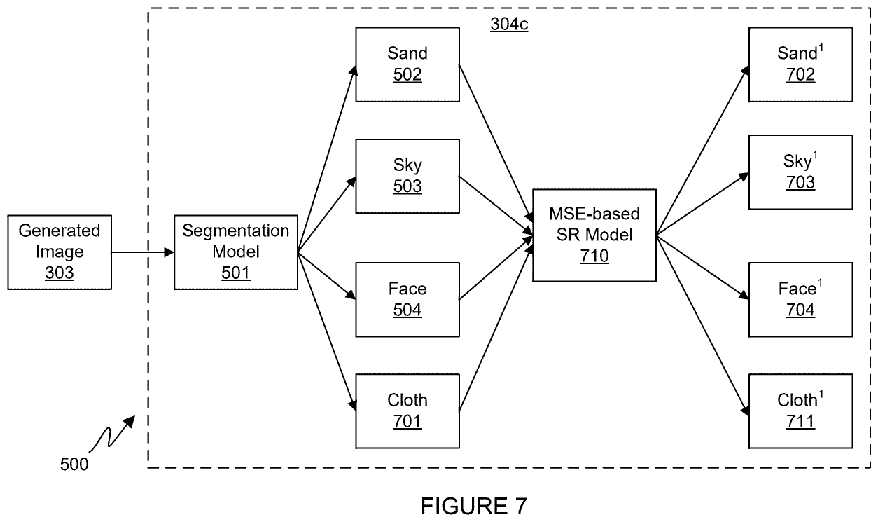

FIG. 7 illustrates an example portion 700 of the processing flow 300 of FIG. 3 according to still other embodiments of this disclosure. In the example shown, a quality check model 304c employs a segmentation-based approach in which the segmentation model 501 segments an image (such as the image of FIG. 4) into different regions. Again, example regions may include the region(s) of sand 502, region(s) of sky 503, regions of face(s) 504, and regions of cloth 701.

The quality check model 304c can pass each segmented image into a mean squared error (MSE)-based super resolution (SR) model or other SR model 710, which processes the segmented image in order to improve the quality of the segmented image. For example, the SR model 710 may output corresponding region(s) of sand 702, region(s) of sky 703, regions of face(s) 704, and regions of cloth 711 each having the same size (1*SR) as the original region. MSE-based models are known for making the output image smooth. The smooth image output for the region(s) of sand 702, region(s) of sky 703, regions of face(s) 704, and regions of cloth 711 are compared with the corresponding region(s) of sand 502, region(s) of sky 503, regions of face(s) 504, and regions of cloth 701 within the generated image 303 to determine a distance therebetween. Many methods to determine the distance between regions compared. For example, a comparison may use a region of interest (ROI) distance check, which could be expressed as follows.

$$δ ( i , j ) = sd ( P ( i - \frac{n - 1}{2} : i + \frac{n - 1}{2} , j - \frac{n - 1}{2} : j + \frac{n - 1}{2} ) ) ,$$

$$d ( x , y ) = {( {δ}_{x} - {δ}_{y} )}^{2} ,$$

Here, δ(i, j) represents local standard deviation at (i, j), sd represents a standard deviation operator, n represents a local window size, x represents a region of the generated image 303, and y represents the corresponding region generated by the MSE-based SR model 710.

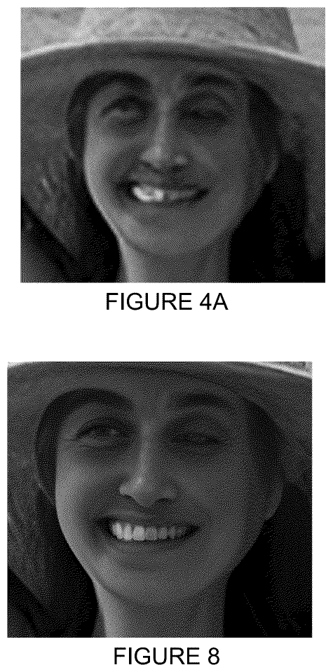

As described above in connection with the processing flow 300 illustrated in FIG. 3, the generated image 303 may be iteratively input into the quality check model 304. If further improvement is needed or desired, the image is restored by one of various different techniques. The process can be repeated until the quality check model 304 determines that the (restored) generated image 303 is adequate. As an example, FIG. 8 illustrates an example of a restored image region corresponding to the region in FIG. 4A in accordance with this disclosure. The quality check model 304 may determine that the restored image region in FIG. 8 may be of sufficient image quality. As noted above, the image restoration technique may employ one or more methods for image restoration, such as an in-paint model and/or a restoration model.

Although FIGS. 5 through 7 illustrate examples of portions of the processing flow 300 of FIG. 3, various changes may be made to FIGS. 5 through 7. For example, various components or operations in each of FIGS. 5 through 7 may be combined, further subdivided, replicated, rearranged, or omitted according to particular needs. Also, additional components or functions may be used in each of FIGS. 5 through 7. Although FIG. 8 illustrates one example of a restored image region corresponding to the region in FIG. 4A, various changes may be made to FIG. 8. For instance, the end result of the image upscaling and restoration shown here is merely meant to illustrate how a specific portion of a specific image might be improved. FIG. 8 does not limit the scope of this disclosure to any particular result of an image upscaling and restoration process.

FIG. 9 illustrates an example portion 900 of the processing flow 300 of FIG. 3 according to one variant of this disclosure. This variant may, for example, be used with any of the approaches shown in FIGS. 5 through 7. In the example shown, a restoration model 305a employs a segmentation-based approach in which the segmentation model 501 segments an image (such as the image of FIG. 4) into different regions, such as the regions of face(s) 504 and region(s) of hand(s) 505. Specific restoration models (such as hand/face restoration model(s)) may be used on detected face/hand regions. The extracted regions of face(s) 504 may be fed into a face restoration model 904, which may perform any suitable face restoration process. In some cases, the face restoration model 904 represents a CodeFormer model. The extracted region(s) of hand(s) 505 may be fed into a hand restoration model 905, which may perform any suitable hand restoration process. In some cases, the hand restoration model 905 represents a HandRefiner model. Outputs of the face restoration model 904 and the hand restoration model 905 can be combined to form a restored image 306a.

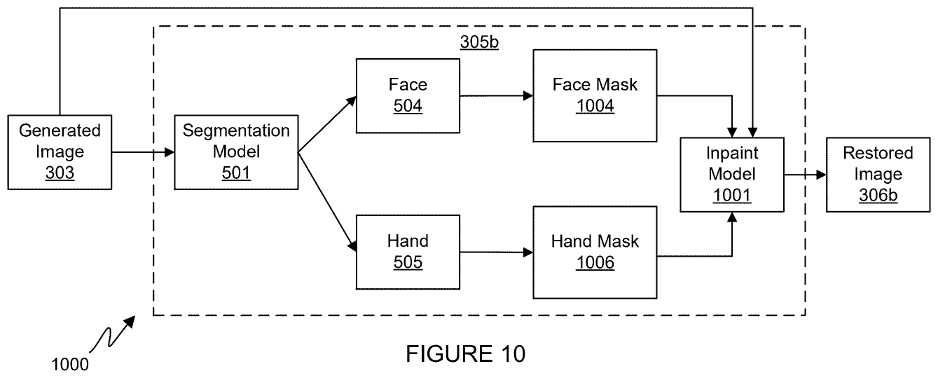

FIG. 10 illustrates an example portion 1000 of the processing flow 300 of FIG. 3 according to another variant of this disclosure. This variant may, for example, be used with any of the approaches shown in FIGS. 5 through 7. In the example shown, a restoration model 305b also employs a segmentation-based approach in which the segmentation model 501 segments an image (such as the image of FIG. 4) into different regions, such as regions of face(s) 504 and region(s) of hand(s) 505. The extracted regions of face(s) 504 and the extracted region(s) of hand(s) 505 may be masked by a face mask 1004 and a hand mask 1006, respectively. The masked regions may be sent to an in-paint model 1001, which can perform image in-painting in order to modify the masked regions. The in-paint model 1001 may represent any suitable model supporting image in-painting, such as a Stable Diffusion model.

Although FIGS. 9 and 10 illustrate examples of portions 900 of the processing flow 300 of FIG. 3, various changes may be made to FIGS. 9 and 10. For example, various components or operations in each of FIGS. 9 and 10 may be combined, further subdivided, replicated, rearranged, or omitted according to particular needs. Also, additional components or functions may be used in each of FIGS. 9 and 10.

In some embodiments, the techniques provided in this disclosure can employ a generative additive network (GAN)-based upscale model including (i) a first model configured to suggest average channel pooling followed by convolutional layers and/or (ii) a second model with a discriminator to provide output with increased diversity.

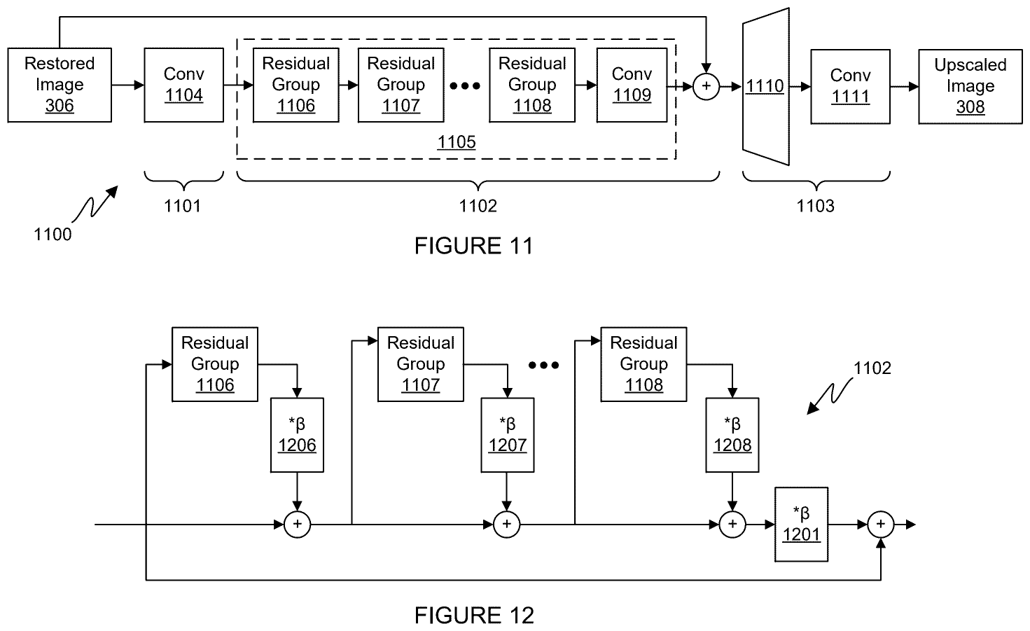

FIG. 11 illustrates an example upscaling portion 1100 of the processing flow 300 of FIG. 3 in accordance with this disclosure. In the example shown, a restored image 306 having a relatively low resolution (or the generated image 303 without restoration) can be processed using shallow feature extraction 1101, deep feature extraction 1102, and upscaling 1103 to generate an upscaled image 308 having a relatively high resolution. In some embodiments, the shallow feature extraction 1101 may be implemented using at least one convolutional layer 1104. The output of the shallow feature extraction 1101 may be processed by what is essentially the structure of a remaining channel attention network 1105 modified as described below. The network 11015 includes a series of residual groups (such as residual groups 1106-1108) and at least one other convolutional layer 1109. The output of the network 1105 is combined with the restored image 306 to form an output of the deep feature extraction 1102. The upsampling 1110 and at least one other convolutional layer 1111 form upscaling 1103, which produces the upscaled image 308.

FIG. 12 illustrates in greater detail an example deep feature extraction 1102 of FIG. 11 in accordance with this disclosure. In the example shown, within the deep feature extraction 1102, the outputs of the residual groups 1106-1108 are processed using corresponding scaling functions 1206-1208. Each of the scaling functions 1206-1208 multiplies the output of the associated residual group 1106-1108 by a factor 8. The output of each scaling function 1206-1208 is combined with the input to the respective residual group 1106-1108, the result of which is provided to the next residual group (if any) in the series. The output of the last function 1208 is processed using a function 1201 and combined with the input to the deep feature extraction 1102 to produce the output of the deep feature extraction 1102.

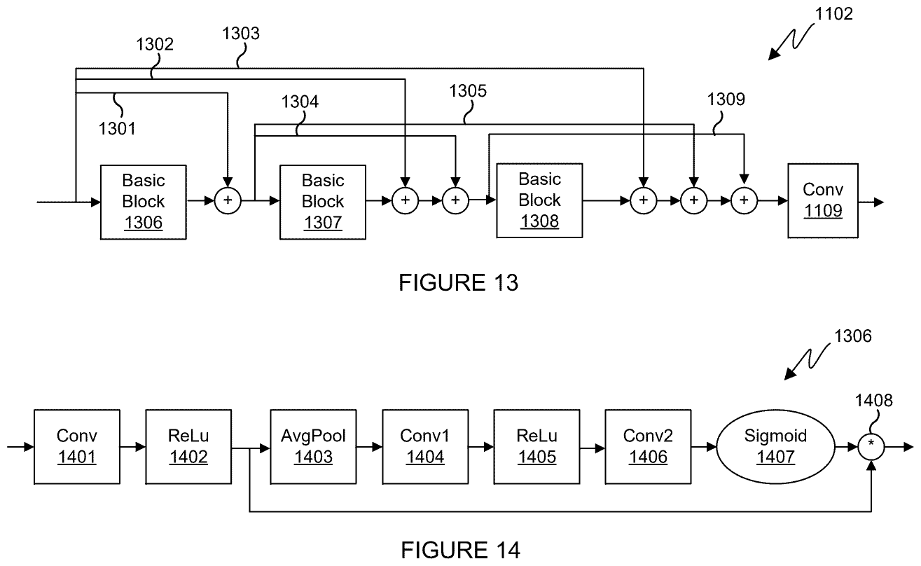

FIG. 13 illustrates in greater detail connections within the deep feature extraction 1102 of FIG. 11 in accordance with this disclosure. In the example shown, basic blocks 1306-1308 represent the residual groups 1106-1108, respectively, within the deep feature extraction 1102. Each basic block 1306-1308 may have the structure depicted in FIG. 12. For each basic block 1306-1308, short skip connections can be added from the input of one processing block to the input(s) of one or more subsequent processing blocks. Thus, short skip connection 1301 connects the input of the basic block 1306 to the input of the basic block 1307, short skip connection 1302 connects the input of the basic block 1306 to the input of the basic block 1308, and short skip connection 1303 connects the input of the basic block 1306 to the input of the convolutional layer 1109. Similarly, short skip connection 1304 connects the input of the basic block 1307 to the input of the basic block 1308, and short skip connection 1305 connects the input of the basic block 1307 to the input of the convolutional layer 1109. Likewise, short skip connection 1309 connects the input of the basic block 1308 to the input of convolutional layer 1109. The addition of these short skip connections may help to provide for faster learning and/or enable the next module to learn from the output of the previous module within the sequence.

FIG. 14 illustrates in greater detail an example structure of the basic block 1306 within the deep feature extraction 1102 of FIG. 11 in accordance with this disclosure. Note that while the basic block 1306 is used as representative, the same structure may be employed for the basic blocks 1307-1308. In the example shown, the basic block receives the input at one or more convolutional layers 1401. An output of the convolutional layer 1401 can be provided to a rectified linear unit (ReLu) 1402, which may return zero for negative values and the input for positive values. An output of the rectified linear unit 1402 can be provided to an average pooling operation (AvgPool) 1403, which may perform downsampling by dividing the input into pooling regions and computing the average value of each region. An output of the average pooling operation 1403 can be provided to at least one first convolutional layer 1404, another rectified linear unit 1405, and at least one second convolutional layer 1406 in series. An output of the second convolutional layer 1406 can be provided to a sigmoid function 1407, which may transform the input into a value within a defined range (such as −1 and +1). An output of the sigmoid function 1407 can be multiplied by the input to the average pooling operation 1403.

Within the basic blocks described above, after a feature passes through the first convolutional layer 1404 and the rectified linear unit 1405, the feature can be represented by image tensor (B, H, W, C), where B represents batch size, H represents height, W represents width, and C represents color channel. The average pooling operation 1403 can convert the input feature to (B*1*1*C), while the first convolutional layer 1404 extracts features in the form of (B*1*1*C/r). The rectified linear unit 1405 can output the same dimension image tensor, from which the second convolutional layer 1406 extracts features in the form of (B*1*1*C). The sigmoid function 1407 can make the output be within the range [−1 . . . 1]. The output of the sigmoid function 1407 can be multiplied with the image tensor (B, H, W, C). In some embodiments, this structure for the basic blocks can make the model focus on high-frequency information (detailed pixels in the image, not smooth pixels in the image).

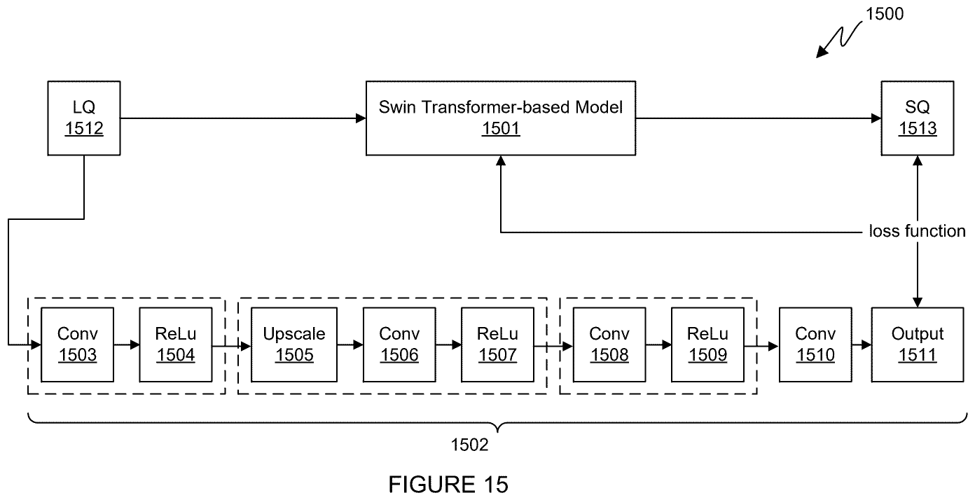

FIG. 15 illustrates another example upscaling portion 1500 of the processing flow 300 of FIG. 3 in accordance with this disclosure. In the example shown, an image upscale model may be implemented with a Swin transformer-based model 1501. Swin transformer-based methods are often trained without a GAN approach and are instead trained only with MSE-based data. In this example, however, after training the model with an MSE-based approach, the Swin transformer-based model 1501 can be fine-tuned with a GAN-based approach by adding a discriminator 1502. Here, the discriminator 1502 includes a sequence of at least one first convolutional layer 1503, a first rectified linear unit 1504, an upscale unit 1505, at least one second convolutional layer 1506, a second rectified linear unit 1507, at least one third convolutional layer 1508, a third rectified linear unit 1509, and at least one fourth convolutional layer 1510. An output 1511 of the discriminator 1502 is processed using a GAN loss function, and the distance between the low quality (LQ) image 1512 and a super-resolution quality (SQ) image 513 is used to finetune the Swin transformer-based model 1501.

Although FIGS. 11 through 15 illustrate examples of upscaling portions of the processing flow 300 of FIG. 3 and related details, various changes may be made to FIGS. 11 through 15. For example, various components or operations in each of FIGS. 11 through 15 may be combined, further subdivided, replicated, rearranged, or omitted according to particular needs. Also, additional components or functions may be used in each of FIGS. 11 through 15.

It should be noted that the functions shown in the figures or described above can be implemented in an electronic device 101, 102, 104, server 106, or other device(s) in any suitable manner. For example, in some embodiments, at least some of the functions shown in the figures or described above can be implemented or supported using one or more software applications or other software instructions that are executed by the processor 120 of the electronic device 101, 102, 104, server 106, or other device(s). In other embodiments, at least some of the functions shown in the figures or described above can be implemented or supported using dedicated hardware components. In general, the functions shown in the figures or described above can be performed using any suitable hardware or any suitable combination of hardware and software/firmware instructions. Also, the functions shown in the figures or described above can be performed by a single device or by multiple devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
obtaining, using at least one processing device of an electronic device, an image created by a generative artificial intelligence (AI) model;
identifying, using the at least one processing device, at least one distortion in the image;
performing, using the at least one processing device, restoration on the at least one identified distortion in the image based on a restoration model to generate a restored image;
upscaling, using the at least one processing device, the restored image based on a generative adversarial network (GAN)-based upscale model to generate an upscaled image; and
outputting, using the at least one processing device, the upscaled image.

2. The method of claim 1, wherein identifying the at least one distortion in the image comprises:
segmenting the image into different regions;
identifying a classification for one of the regions;
determining a confidence associated with the region based on the classification; and
identifying the at least one distortion based on the confidence not exceeding a confidence threshold.

3. The method of claim 2, further comprising:
obtaining a text prompt used by the generative AI model to generate the image; and
determining the classification associated with the region based on the text prompt.

4. The method of claim 1, wherein identifying the at least one distortion in the image comprises:
obtaining a text prompt used by the generative AI model to generate the image;
generating a negative prompt based on the text prompt;
obtaining a negative image created by the generative AI model based on the negative prompt; and
identifying that the image needs an additional restoration based on a distance between the negative image from the image not exceeding a distance threshold.

5. The method of claim 1, wherein identifying the at least one distortion in the image comprises:
segmenting the image into different regions;
smoothing one of the regions using a super resolution (SR) model;
performing a region of interest (ROI) distance check between the region and the smoothed region; and
identifying the at least one distortion based on a distance from the ROI distance check not exceeding a distance threshold.

6. The method of claim 1, wherein upscaling the restored image comprises:
performing an average pooling operation on the restored image;
performing a first convolution operation on a result of the average pooling operation;
performing a first rectified linear unit (ReLU) activation operation on a result of the first convolution operation;
performing a second convolution operation on a result of the first ReLU activation operation;
performing a sigmoid operation on a result of the second convolution operation; and
generating an output model by multiplying a result of the sigmoid operation by features of the restored image.

7. The method of claim 6, wherein upscaling the restored image further comprises:
combining the output model with the restored image to generate a combined model;
performing a second average pooling operation on the combined model;
performing a third convolution operation on a result of the second average pooling operation;
performing a second ReLU activation operation on a result of the third convolution operation;
performing a fourth convolution operation on a result of the second ReLu activation operation;
performing a second sigmoid operation on a result of the fourth convolution operation; and
generating a second output model by multiplying a result of the second sigmoid operation by features of the combined model.

8. An electronic device comprising:
at least one processing device configured to:
obtain an image created by a generative artificial intelligence (AI) model;
identify at least one distortion in the image;
perform restoration on the at least one identified distortion in the image based on a restoration model to generate a restored image;
upscale the restored image based on a generative adversarial network (GAN)-based upscale model to generate an upscaled image; and
output the upscaled image.

9. The electronic device of claim 8, wherein, to identify the at least one distortion in the image, the at least one processing device is configured to:
segment the image into different regions;
identify a classification for one of the regions;
determine a confidence associated with the region based on the classification; and
identify the at least one distortion based on the confidence not exceeding a confidence threshold.

10. The electronic device of claim 9, wherein the at least one processing device is further configured to:
obtain a text prompt used by the generative AI model to generate the image; and
determine the classification associated with the region based on the text prompt.

11. The electronic device of claim 8, wherein, to identify the at least one distortion in the image, the at least one processing device is configured to:
obtain a text prompt used by the generative AI model to generate the image;
generate a negative prompt based on the text prompt;
obtain a negative image created by the generative AI model based on the negative prompt; and
identify that the image needs an additional restoration based on a distance between the negative image from the image not exceeding a distance threshold.

12. The electronic device of claim 8, wherein, to identify the at least one distortion in the image, the at least one processing device is configured to:
segment the image into different regions;
smooth one of the regions using a super resolution (SR) model;
perform a region of interest (ROI) distance check between the region and the smoothed region; and
identify the at least one distortion based on a distance from the ROI distance check not exceeding a distance threshold.

13. The electronic device of claim 8, wherein, to upscale the restored image, the at least one processing device is configured to:
perform an average pooling operation on the restored image;
perform a first convolution operation on a result of the average pooling operation;
perform a first rectified linear unit (ReLU) activation operation on a result of the first convolution operation;
perform a second convolution operation on a result of the first ReLU activation operation;
perform a sigmoid operation on a result of the second convolution operation; and
generate an output model by multiplying a result of the sigmoid operation by features of the restored image.

14. The electronic device of claim 13, wherein, to upscale the restored image, the at least one processing device is further configured to:
combine the output model with the restored image to generate a combined model;
perform a second average pooling operation on the combined model;
perform a third convolution operation on a result of the second average pooling operation;
perform a second ReLU activation operation on a result of the third convolution operation;
perform a fourth convolution operation on a result of the second ReLu activation operation;
perform a second sigmoid operation on a result of the fourth convolution operation; and
generate a second output model by multiplying a result of the second sigmoid operation by features of the combined model.

15. A non-transitory machine-readable medium containing instructions that when executed cause at least one processor to:
obtain an image created by a generative artificial intelligence (AI) model;
identify at least one distortion in the image;
perform restoration on the at least one identified distortion in the image based on a restoration model to generate a restored image;
upscale the restored image based on a generative adversarial network (GAN)-based upscale model to generate an upscaled image; and
output the upscaled image.

16. The non-transitory machine-readable medium of claim 15, wherein the instructions that when executed cause the at least one processor to identify the at least one distortion in the image comprise instructions that when executed cause the at least one processor to:
segment the image into different regions;
identify a classification for one of the regions;
determine a confidence associated with the region based on the classification; and
identify the at least one distortion based on the confidence not exceeding a confidence threshold.

17. The non-transitory machine-readable medium of claim 15, wherein the instructions that when executed cause the at least one processor to identify the at least one distortion in the image comprise instructions that when executed cause the at least one processor to:
obtain a text prompt used by the generative AI model to generate the image;
generate a negative prompt based on the text prompt;
obtain a negative image created by the generative AI model based on the negative prompt; and
identify that the image needs an additional restoration based on a distance between the negative image from the image not exceeding a distance threshold.

18. The non-transitory machine-readable medium of claim 15, wherein the instructions that when executed cause the at least one processor to identify the at least one distortion in the image comprise instructions that when executed cause the at least one processor to:
segment the image into different regions;
smooth one of the regions using a super resolution (SR) model;
perform a region of interest (ROI) distance check between the region and the smoothed region; and
identify the at least one distortion based on a distance from the ROI distance check not exceeding a distance threshold.

19. The non-transitory machine-readable medium of claim 15, wherein the instructions that when executed cause the at least one processor to upscale the restored image comprise instructions that when executed cause the at least one processor to:
perform an average pooling operation on the restored image;
perform a first convolution operation on a result of the average pooling operation;
perform a first rectified linear unit (ReLU) activation operation on a result of the first convolution operation;
perform a second convolution operation on a result of the first ReLU activation operation;
perform a sigmoid operation on a result of the second convolution operation; and
generate an output model by multiplying a result of the sigmoid operation by features of the restored image.

20. The non-transitory machine-readable medium of claim 19, wherein the instructions that when executed cause the at least one processor to upscale the restored image further comprise instructions that when executed cause the at least one processor to:
combine the output model with the restored image to generate a combined model;
perform a second average pooling operation on the combined model;
perform a third convolution operation on a result of the second average pooling operation;
perform a second ReLU activation operation on a result of the third convolution operation;
perform a fourth convolution operation on a result of the second ReLu activation operation;
perform a second sigmoid operation on a result of the fourth convolution operation; and
generate a second output model by multiplying a result of the second sigmoid operation by features of the combined model.
